(19) United States
(12) Patent Application Publication
(10) Pub. No.: US 2015/0379087 A1
(43) Pub. Date: Dec. 31, 2015

(54) APPARATUS AND METHOD FOR REPLYING TO QUERY

(71) Applicant: Electronics and Telecommunications Research Institute, Daejeon (KR)

(72) Inventors: Hyung-Jik LEE, Daejeon (KR); Young-Rae KIM, Daejeon (KR); Hyun-Ki KIM, Daejeon (KR); Pum-Mo RYU, Daejeon (KR); Jin-Young MOON, Daejeon (KR); Chang-Seok BAE, Daejeon (KR)

(21) Appl. No.: 14/604,032

(22) Filed: Jan. 23, 2015

(30) Foreign Application Priority Data
Jun. 30, 2014 (KR) 10-2014-0081090

(51) Int. Cl. G06F 17/30

(52) U.S. Cl. CPC G06F 17/30522; G06F 17/30536

(57) ABSTRACT

Disclosed are an apparatus and a method for replying to a query. The apparatus for replying to a query includes: a query reply processing unit configured to generate candidates of correct answers by analyzing a question of a user who has inputted a query and searching knowledge database and document database based on a result of analyzing the question and configured to infer a final correct answer from the candidates of correct answers; an inference information generating unit configured to generate a reference corpus and a word inquiry, which are inference information for inferring a knowledge level of a user of little or no information; and a knowledge level inferring unit configured to generate knowledge level information by inferring the knowledge level of the user by use of the reference corpus and the word inquiry and provide the knowledge level information to the query reply processing unit.

### CROSS-REFERENCE TO RELATED APPLICATIONS

This application claims priority to and the benefit of Korean Patent Application No. 10-2014-0081090, filed with the Korean Intellectual Property Office on Jun. 30, 2014, the disclosure of which is incorporated herein by reference in its entirety.

### BACKGROUND

1. Technical Field

The present invention relates to an apparatus and a method for replying to a query.

2. Background Art

In the conventional method of replying to a query, a key query word is extracted by analyzing a user's natural-language query, and the extracted query word is compared with key words of database to provide a reply corresponding to a key word.

This method, however, does not take the level of knowledge of the user into consideration and thus is limited with providing the same level of information to every user. Accordingly, an expert level of information may be provided to a person having an elementary school level of knowledge, or a very mediocre level of information to an expert.

### SUMMARY

The present invention provides an apparatus and a method for replying to a query that can infer the level of knowledge of a user to provide a reply reflecting the level of knowledge of the user.

As aspect of the present invention discloses an apparatus for replying to a query.

The apparatus for replying to a query in accordance with an embodiment of the present invention can include: a query reply processing unit configured to generate candidates of correct answers by analyzing a question of a user who has inputted a query and searching knowledge database and document database based on a result of analyzing the question and configured to infer a final correct answer from the candidates of correct answers; an inference information generating unit configured to generate a reference corpus and a word inquiry, which are inference information for inferring a knowledge level of a user of little or no information; and a knowledge level inferring unit configured to generate knowledge level information by inferring the knowledge level of the user by use of the reference corpus and the word inquiry and provide the knowledge level information to the query reply processing unit. The query reply processing unit can use the knowledge level information to generate candidates of correct answers corresponding to the knowledge level of the user and infer a final correct answer.

The inference information generating unit can include a corpus generating module configured to perform at least one function of analyzing a language and a text, grouping question domains corresponding to user question and grouping users demographically, collecting a query reply log for each user, and generating a reference corpus of a reference group.

The inference information generating unit can include a word inquiry module configured to generate a word inquiry by generating language use information per language analysis, question domain characteristic, situation, psychological state and individual by performing linguistic analysis of a sentence used for the question by the user, question domain characteristic and situation analysis of collecting and analyzing use of words and based on characteristics of the question domain and situation information of the user, psychological and personal characteristic analysis of analyzing use of words based on psychological situation and characteristics of frequent words used personally by the user and by extracting variables of the knowledge level in the user's question.

The user who has inputted the query can be distinguished into a real-name user who is logged in and an anonymous user who is not logged in, and the anonymous user can be a user who is using the apparatus for replying to a query for the first time or has used the apparatus for replying to a query fewer times than a predetermined number, or can be a user who has signed up but not logged in.

The knowledge level inferring unit can be configured to perform a function of inferring the knowledge level of the anonymous user by use of the reference corpus and the word inquiry based on the result of the language, question domain characteristic, situation, psychological state and individual analyses.

The knowledge level inferring unit can be configured to generate a temporary corpus in order to infer the knowledge level of the anonymous user and store the temporary corpus in temporary corpus database and can be configured to transfer the temporary corpus to corpus database and store the transferred temporary corpus in the corpus database if the user is identified later.

In the case of inferring the knowledge level of the real-name user, the knowledge level inferring unit can be configured to search knowledge level information of the question domain of the real-name user in user model database and provide the searched knowledge level information to the query reply processing unit.

The knowledge level inferring unit can be configured to perform at least one of a function of analyzing a reply feedback, a function of inferring the knowledge level based on a dialogue, a function of learning and managing the word inquiry, and a function of learning and managing a user model.

In case the user gives a feedback to a reply to keep asking questions through a dialogue, the knowledge level inferring unit can be configured to infer the knowledge level based on the dialogue and additionally infer a level of satisfaction for the reply and the knowledge level of the user by analyzing the feedback to the reply.

Another aspect of the present invention discloses a method for replying to a query that is performed by an apparatus for replying to a query.

The method for replying to a query in accordance with an embodiment of the present invention can include: determining whether a user who has inputted a query is an anonymous user; in case the user is an anonymous user, generating a temporary corpus temporarily in order to inter a knowledge level of the anonymous user; analyzing a question of the user who has inputted the query and obtaining a result of analyzing the question; generating a reference corpus and a word inquiry, which are inference information for inferring the knowledge level of the anonymous user; generating knowledge level information by inferring the knowledge level of the user by use of the reference corpus and the word inquiry; and generating candidates of correct answers corresponding to the knowledge level of the user who has inputted the query by searching knowledge database and document database based on the result of analyzing the question and inferring a final correct answer from the candidates of correct answers.

The generating of the reference corpus and the word inquiry can include performing at least one function of analyzing a language and a text, grouping question domains corresponding to user question and grouping users demographically, collecting a query reply log for each user, and generating a reference corpus of a reference group.

The generating of the reference corpus and the word inquiry can include generating the word inquiry by generating language use information per language analysis, question domain characteristic, situation, psychological state and individual by performing linguistic analysis of a sentence used for the question by the user, question domain characteristic and situation analysis of collecting and analyzing use of words and based on characteristics of the question domain and situation information of the user, psychological and personal characteristic analysis of analyzing use of words based on psychological situation and characteristics of frequent words used personally by the user and by extracting variables of the knowledge level in the user's question.

The user who has inputted the query can be distinguished into a real-name user who is logged in and the anonymous user who is not logged in, and the anonymous user can be a user who is using the apparatus for replying to a query for the first time or has used the apparatus for replying to a query fewer times than a predetermined number, or can be a user who has signed up but not logged in.

The generating of the knowledge level information can include performing a function of inferring the knowledge level of the anonymous user by use of the reference corpus and the word inquiry based on the result of the language, question domain characteristic, situation, psychological state and individual analyses.

The generating of the temporary corpus can include storing the temporary corpus in temporary corpus database, and the temporary corpus can be transferred to and stored in corpus database if the user is identified later.

In case the user who has inputted the query is the real-name user, knowledge level information of the question domain of the real-name user can be searched in user model database.

The method for replying to a query can further include at least one of, in case the user gives a reply feedback: analyzing a reply feedback; inferring the knowledge level based on a dialogue; learning and managing the word inquiry; and learning and managing a user model.

The inferring of the knowledge level based on a dialogue can include, in case the user continues asking questions through the dialogue by giving the reply feedback, inferring the knowledge level based on the dialogue, and the analyzing of the reply feedback can include additionally inferring a level of satisfaction for the reply and the knowledge level of the user.

With the present invention, the level of knowledge of the user can be inferred, and a reply reflecting the level of knowledge of the user can be provided, when a query of the user is replied.

### BRIEF DESCRIPTION OF THE DRAWINGS

FIG. 1 is a block diagram briefly showing the configuration of an apparatus for replying to a query in accordance with an embodiment of the present invention.

FIG. 2 is a flow diagram illustrating a method for replying to a query with the apparatus for replying to a query shown in FIG. 1.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain technology is determined to evade the point of the present invention, the pertinent detailed description will be omitted. Numerals (e.g., first, second, etc.) used in the description of the present invention are only for distinguishing one element from another element.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

Hereinafter, some embodiments will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain technology is determined to evade the point of the present invention, the pertinent detailed description will be omitted.

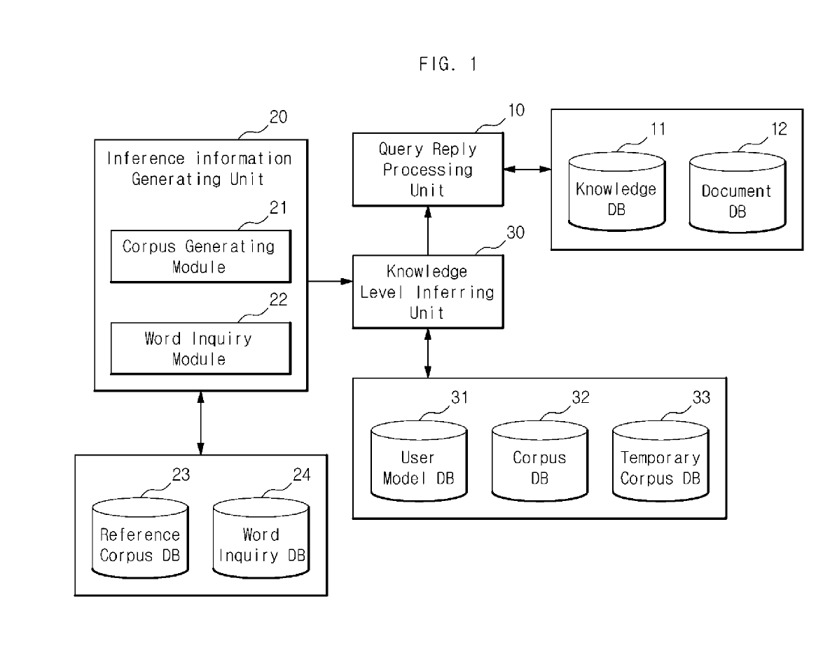

FIG. 1 is a block diagram briefly showing the configuration of an apparatus for replying to a query in accordance with an embodiment of the present invention.

Referring to FIG. 1, the apparatus for replying to a query includes a query reply processing unit 10, an inference information generating unit 20 and a knowledge level inferring unit 30. Here, the query reply processing unit 10 can include knowledge database 11 and document database 12, and the inference information generating unit 20 can include reference corpus database 23 and word inquiry database 24, and the knowledge level inferring unit 30 can include user model database 31, corpus database 32 and temporary corpus database 33.

The query reply processing unit 10 establishes an optimal reply strategy by analyzing a question made by a user, generates candidates of correct answers by searching the knowledge database 11 and the document database 12 based on a result of analyzing the question according to the established reply strategy, and infers a final correct answer by prioritizing, synthesizing and verifying the candidates of correct answers.

Here, the query reply processing unit 10 uses knowledge level information of the user transferred from the knowledge level inferring unit 30 to generate the candidates of correct answers matching with the knowledge level of the user and to infer the final correct answer.

The inference information generating unit 20 generates inference information that is used for inference of the knowledge level of the user for which no or little information is available. Specifically, the inference information generating unit 20 can generate and have reference corpus and word query stored in the reference corpus database 23 and the word inquiry database 24.

The inference information generating unit 20 includes a corpus generating module 21 and a word inquiry module 22.

The corpus generating module 21 performs a function of analyzing a language and a text, a function of grouping question domains corresponding to user question and grouping users demographically, a function of collecting a query reply log for each user, and a function of generating a reference corpus of a reference group.

For example, the question domains of the user question can be grouped to language/literature, society/culture, science, art, current affairs/general knowledge, personalities, miscellaneous, etc., and the users can be grouped based on age, gender, occupation, education, etc. The corpus generating module 21 can collect the query reply log of the users using the apparatus for replying to a query through a survey or a terminal and generate the reference corpus, in which the collected query reply log is organized based on the question domains and the user groups.

The word inquiry module 22 performs a function of distinguishing multiple variables in order to infer variables of the knowledge level of the user and performs linguistic analysis (e.g., morpheme, word, sentence structure and form, sentence length, etc.) of a sentence used for the question by the user. Moreover, the word inquiry module 22 collects and analyzes use information of words (e.g., acronyms, technical terms, newly-coined words, etc.) according to the properties of the question domains and situation information of the user, for example, time, place, etc., and analyzes the use of words based on a psychological condition and the characteristics of frequent words used personally by the user. Moreover, the word inquiry module 22 generates a word inquiry by extracting the variables of the knowledge level in the user's question and generating language use information per language analysis, question domain characteristic, situation, psychological state and individual.

The knowledge level inferring unit 30 generates knowledge level information by inferring the knowledge level of the user by use of the reference corpus and the word inquiry generated by the inference information generating unit 20 and transfers the generated knowledge level information to the inquiry reply processing unit 10.

For instance, the knowledge level inferring unit 30 can distinguish the knowledge level of the user into elementary, intermediate, high and expert levels to determine the knowledge level of the user. The user can be distinguished into a real-name user, who is logged in the apparatus for replying to a query, and an anonymous user, who is not logged in the apparatus for replying to a query. The anonymous user may be someone who is using the apparatus for replying to a query for the first time or has used the apparatus for replying to a query fewer times than a predetermined number, or may be someone who has signed up but not logged in.

Based on the result of the language, question domain characteristic, situation, psychological state and individual analyses performed by the word inquiry module 22, the knowledge level inferring unit 30 performs a function of inferring the knowledge level of the anonymous user by use of the reference corpus and the word inquiry. For this, the knowledge level inferring unit 30 generates and manages a temporary corpus, which is temporarily stored in the temporary corpus database 33. Other than analyzing the knowledge level of the anonymous user, it is also possible for the knowledge level inferring unit 30 to have a desired knowledge level inputted directly by the user. Later, when the user is identified, the knowledge level inferring unit 30 transfers the temporary corpus that is temporarily stored in the temporary corpus database 33 to the corpus database 32 and stores the transferred temporary corpus in the corpus database 32.

In the case of inferring the knowledge level of the logged-in real-name user, the knowledge level inferring unit 30 searches knowledge level information of a question domain of the real-name user in the user model database 31 and provides the knowledge level information of the user to the query reply processing unit 10 according to a request of the query reply processing unit 10.

Moreover, the knowledge level inferring unit 30 performs a function of analyzing a reply feedback, a function of inferring the knowledge level based on a dialogue, a function of learning and managing the word inquiry, and a function of learning and managing a user model. For instance, the knowledge level inferring unit 30 can infer the knowledge level of the user in case the user gives a feedback to a reply to keep asking questions through a dialogue with the apparatus for replying to a query. Moreover, the knowledge level inferring unit 30 can additionally infer a level of satisfaction for the reply and the knowledge level of the user by analyzing the feedback to the reply. Moreover, by analyzing a log that has been stored for an extended period while the user is using the apparatus for replying to a query, the knowledge level inferring unit 30 can determine whether there is any information to be changed to change the word inquiry that is already stored in the word inquiry database 24. Moreover, the knowledge level inferring unit 30 can update the user model by continuously monitoring the change of knowledge level and characteristics of the user and can continuously store the corpus of the user.

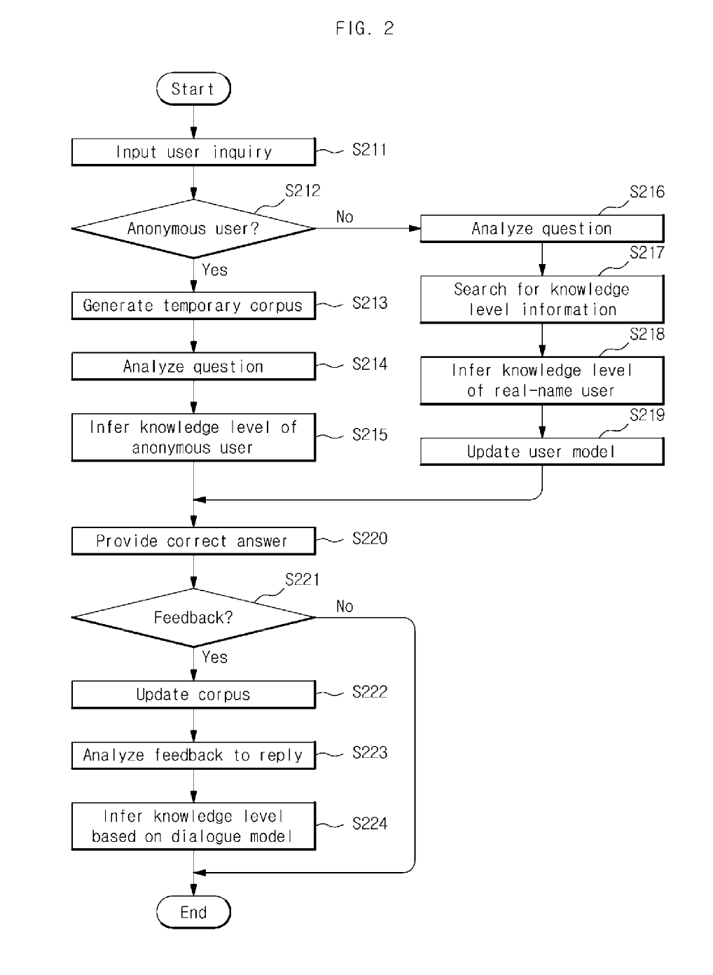

FIG. 2 is a flow diagram illustrating a method for replying to a query with the apparatus for replying to a query shown in FIG. 1.

In step S211, the apparatus for replying to a query has a user inquiry inputted thereto from a user.

In step S212, the apparatus for replying to a query determines whether the user having inputted the inquiry is an anonymous user. For instance, the user can be distinguished into a real-name user, who is logged in the apparatus for replying to a query, and an anonymous user, who is not logged in the apparatus for replying to a query. The anonymous user may be someone who is using the apparatus for replying to a query for the first time or has used the apparatus for replying to a query fewer times than a predetermined number, or may be someone who has signed up but not logged in.

In step S213, the apparatus for replying to a query generates a temporary corpus for the user and stores a query reply log if the user having inputted the query is an anonymous user.

In step S214, the apparatus for replying to a query analyzes a question of the inputted query. The apparatus for replying to a query assesses a question domain of the question of the user through the analysis of the question and establishes a strategy for reply.

In step S215, the apparatus for replying to a query infer a knowledge level of the anonymous user. That is, the apparatus for replying to a query infers the knowledge level about the question domain of the user by comparing a result of analysis of knowledge variables of the user question with a reference corpus through the word inquiry. For example, the result of analysis of knowledge variables can be a result obtained by performing language analysis, question domain characteristic and situation analysis, and psychological and individual characteristic analysis.

In step S216, if the user having inputted the query is a real-name user, the apparatus for replying to a query analyzes a question of the query inputted by the real-name user, as in step S214.

In step S217, the apparatus for replying to a query searches for knowledge level information of the real-name user. That is, the apparatus for replying to a query can search for the knowledge level information of the question domain of the real-name user in user model database 31.

In step S218, the apparatus for replying to a query infers the knowledge level of the real-name user by using the searched knowledge level information.

In step S219, the apparatus for replying to a query continuously monitors a change of knowledge level and characteristics of the user and updates a user model.

In step S220, the apparatus for replying to a query uses the knowledge level information of the user to generate candidates of correct answers matching with the knowledge level of the user and to infer and provide the final correct answer.

For example, provided that the user has made a query about a science field, and if the knowledge level of the user is inferred to be an elementary level based on the rudimentary words and sentence of the question, the apparatus for replying to a query searches for the correct answer among the elementary level of knowledge tagged to knowledge, document and paragraph information.

In step S221, the apparatus for replying to a query determines whether a feedback to the reply is made by the user for the provided correct answer.

In step S222, the apparatus for replying to a query updates a temporary corpus and a corpus of the user if the user provides the feedback to the reply.

In step S223, the apparatus for replying to a query analyzes the feedback to the reply. By analyzing the feedback to the reply, the apparatus for replying to a query can additionally infer a satisfaction for the reply and the knowledge level of the user. For instance, through the feedback to the reply, the apparatus for replying to a query can analyze whether the user requires a higher level of information and whether the user is satisfied with the correct. Moreover, if a satisfied feedback is received after the higher level of information required by the real-name user is provided, the apparatus for replying to a query can update the user model to reflect that the knowledge level of the user to the question domain has been elevated.

In step S224, the apparatus for replying to a query infers the knowledge level of the user in case the user continues to ask questions through a dialogue with the apparatus for replying to a query by giving the feedback to the reply.

Afterwards, if identification information of the user is inputted before termination, the apparatus for replying to a query can either update the user model or newly register user information, depending on whether there is previously registered user information.

The method for motion estimation according to an embodiment of the present invention may be implemented as a form of program instructions executable through various means for electronically processing information and written in a storage medium, which may include program instructions, data files, data structures or any combination thereof.

The program instructions stored in the storage medium can be designed and configured specifically for the present invention or can be publically known and available to those who are skilled in the field of software. Examples of the storage medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

While the present invention has been described with reference to certain embodiments, the embodiments are for illustrative purposes only and shall not limit the invention. It is to be appreciated that those skilled in the art can change or modify the embodiments without departing from the scope and spirit of the invention.

What is claimed is:

1. An apparatus for replying to a query, comprising:
a query reply processing unit configured to generate candidates of correct answers by analyzing a question of a user who has inputted a query and searching knowledge database and document database based on a result of analyzing the question and configured to infer a final correct answer from the candidates of correct answers;
an inference information generating unit configured to generate a reference corpus and a word inquiry, which are inference information for inferring a knowledge level of a user of little or no information; and
a knowledge level inferring unit configured to generate knowledge level information by inferring the knowledge level of the user by use of the reference corpus and the word inquiry and provide the knowledge level information to the query reply processing unit,
wherein the query reply processing unit is configured to use the knowledge level information to generate candidates of correct answers corresponding to the knowledge level of the user who has inputted the query and infer a final correct answer.

2. The apparatus of claim 1, wherein the inference information generating unit comprises a corpus generating module configured to perform at least one function of analyzing a language and a text, grouping question domains corresponding to user question and grouping users demographically, collecting a query reply log for each user, and generating a reference corpus of a reference group.

3. The apparatus of claim 2, wherein the inference information generating unit comprises a word inquiry module configured to generate a word inquiry by generating language use information per language analysis, question domain characteristic, situation, psychological state and individual by performing linguistic analysis of a sentence used for the question by the user, question domain characteristic and situation analysis of collecting and analyzing use of words and based on characteristics of the question domain and situation information of the user, psychological and personal characteristic analysis of analyzing use of words based on psychological situation and characteristics of frequent words used personally by the user and by extracting variables of the knowledge level in the user's question.

4. The apparatus of claim 3, wherein the user who has inputted the query is distinguished into a real-name user who is logged in and an anonymous user who is not logged in, and wherein the anonymous user is a user who is using the apparatus for replying to a query for the first time or has used the apparatus for replying to a query fewer times than a predetermined number, or is a user who has signed up but not logged in.

5. The apparatus of claim 4, wherein the knowledge level inferring unit is configured to perform a function of inferring the knowledge level of the anonymous user by use of the reference corpus and the word inquiry based on the result of the language, question domain characteristic, situation, psychological state and individual analyses.

6. The apparatus of claim 5, wherein the knowledge level inferring unit is configured to generate a temporary corpus in order to infer the knowledge level of the anonymous user and store the temporary corpus in temporary corpus database and configured to transfer the temporary corpus to corpus database and store the transferred temporary corpus in the corpus database if the user is identified later.

7. The apparatus of claim 4, wherein, in the case of inferring the knowledge level of the real-name user, the knowledge level inferring unit is configured to search knowledge level information of the question domain of the real-name user in user model database and provide the searched knowledge level information to the query reply processing unit.

8. The apparatus of claim 1, wherein the knowledge level inferring unit is configured to perform at least one of a function of analyzing a reply feedback, a function of inferring the knowledge level based on a dialogue, a function of learning and managing the word inquiry, and a function of learning and managing a user model.

9. The apparatus of claim 8, wherein, in case the user gives a feedback to a reply to keep asking questions through a dialogue, the knowledge level inferring unit is configured to infer the knowledge level based on the dialogue and additionally infer a level of satisfaction for the reply and the knowledge level of the user by analyzing the feedback to the reply.

10. A method for replying to a query, the method being performed by an apparatus for replying to a query and comprising:
determining whether a user who has inputted a query is an anonymous user;
in case the user is an anonymous user, generating a temporary corpus temporarily in order to inter a knowledge level of the anonymous user;
analyzing a question of the user who has inputted the query and obtaining a result of analyzing the question;
generating a reference corpus and a word inquiry, which are inference information for inferring the knowledge level of the anonymous user;
generating knowledge level information by inferring the knowledge level of the user by use of the reference corpus and the word inquiry; and
generating candidates of correct answers corresponding to the knowledge level of the user who has inputted the query by searching knowledge database and document database based on the result of analyzing the question and inferring a final correct answer from the candidates of correct answers.

11. The method of claim 10, wherein the generating of the reference corpus and the word inquiry comprises performing at least one function of analyzing a language and a text, grouping question domains corresponding to user question and grouping users demographically, collecting a query reply log for each user, and generating a reference corpus of a reference group.

12. The method of claim 11, wherein the generating of the reference corpus and the word inquiry comprises generating the word inquiry by generating language use information per language analysis, question domain characteristic, situation, psychological state and individual by performing linguistic analysis of a sentence used for the question by the user, question domain characteristic and situation analysis of collecting and analyzing use of words and based on characteristics of the question domain and situation information of the user, psychological and personal characteristic analysis of analyzing use of words based on psychological situation and characteristics of frequent words used personally by the user and by extracting variables of the knowledge level in the user's question.

13. The method of claim 12, wherein the user who has inputted the query is distinguished into a real-name user who is logged in and the anonymous user who is not logged in, and wherein the anonymous user is a user who is using the apparatus for replying to a query for the first time or has used the apparatus for replying to a query fewer times than a predetermined number, or is a user who has signed up but not logged in.

14. The method of claim 13, wherein the generating of the knowledge level information comprises performing a function of inferring the knowledge level of the anonymous user by use of the reference corpus and the word inquiry based on the result of the language, question domain characteristic, situation, psychological state and individual analyses.

15. The method of claim 14, wherein the generating of the temporary corpus comprises storing the temporary corpus in temporary corpus database, and
wherein the temporary corpus is transferred to and stored in corpus database if the user is identified later.

16. The method of claim 13, wherein, in case the user who has inputted the query is the real-name user, knowledge level information of the question domain of the real-name user is searched in user model database.

17. The method of claim 10, further comprising at least one of, in case the user gives a reply feedback:
analyzing a reply feedback;
inferring the knowledge level based on a dialogue;
learning and managing the word inquiry; and
learning and managing a user model.

18. The method of claim 17, wherein the inferring of the knowledge level based on a dialogue comprises, in case the user continues asking questions through the dialogue by giving the reply feedback, inferring the knowledge level based on the dialogue, and
wherein the analyzing of the reply feedback comprises additionally inferring a level of satisfaction for the reply and the knowledge level of the user.
